(19) United States
(12) Patent Application Publication
(10) Pub. No.: US 2019/0265376 A1
(43) Pub. Date: Aug. 29, 2019

(54) METHOD OF EXTRACTING INTRINSIC ATTENTUATION FROM SEISMIC DATA

(71) Applicant: ExxonMobil Research and Engineering Company, Annandale, NJ (US)

(72) Inventors: Stefan S. Natu, Jersey City, NJ (US); Mehmet D. Ertas, Bethlehem, PA (US); Harry W. Deckman, Clinton, NJ (US)

(21) Appl. No.: 16/251,255

(22) Filed: Jan. 18, 2019

Related U.S. Application Data
(60) Provisional application No. 62/634,241, filed on Feb. 23, 2018.

(51) Int. Cl. G01V 1/30

(52) U.S. Cl. CPC G01V 1/306; G01V 1/307; G01V 1/308

(57) ABSTRACT

The present disclosure generally relates to a computer-implemented method for determining intrinsic attenuation in a region of a subsurface. The method generally includes obtaining seismic data around the region of the subsurface; processing the seismic data to obtain a reflectivity spectrum in the region of the subsurface; fitting the reflectivity spectrum to analytic formulas as a function of frequency; and determining the intrinsic attenuation in the region of the subsurface based on the fitting. Other aspects of the present disclosure relate to a computer-implemented method for determining the thickness of a thin subsurface bed at a horizon of interest.

### CROSS-REFERENCE TO RELATED APPLICATIONS

This application claims priority to U.S. Provisional Application Ser. No. 62/634,241 filed Feb. 23, 2018, which is herein incorporated by reference in its entirety.

### FIELD

The present disclosure is directed generally to the field of seismic data processing. Specifically, the disclosure presents a method for extracting intrinsic attenuation from seismic data.

### BACKGROUND

For several decades, the oil and gas industry has used the properties of seismic waves reflecting from beneath the earth's surface as a tool to detect the presence of hydrocarbons. Seismic signals recorded by detectors are typically processed to yield information about the reflection coefficient or reflectivity—the amount of wave energy reflected from a region of the subsurface. The reflectivity in turn provides information about petrophysical properties of the region, such as the density, pressure, and shear wave velocity, or functions of the density and velocities, such as the impedance or elastic moduli in the medium.

It is well known that the type of fluids inside the pores of rocks affect their seismic response. Further information about the rock properties can be obtained by plotting the reflectivity versus source-receiver distance, a method known as amplitude versus offset (AVO). Fluids change the density and moduli of the rocks whose pore space the fluids occupy, thereby modifying the reflection signal in known ways. These theories are based on changes to elastic properties, and the resulting reflectivities between individual layers are real and independent of the frequency of the incident seismic wave.

The fluid substitution information that AVO provides gives no information about fluid mobility and in general only works on elastic formations that are less than 50 million years old. In such formations the elastic modulus responds to the type of fluid in the pore space. In hard formations such as carbonates and older rocks, the elastic modulus does not respond to the type of fluid substitution, and as such it is impossible to obtain a direct hydrocarbon indicator in such formations.

A second method common in seismic processing is spectral decomposition. This method decomposes reflectivities into a set of components as a function of frequency and aims at analyzing seismic data in the time-frequency domain. For purely elastic media, the reflected wave can have different spectral content than the incident wave due to interference effects from closely spaced layers below the spatial resolution of the seismic wave, giving rise to a reflectivity spectrum that has frequency dependence revealed by spectral decomposition. Thus, variations in the reflectivity spectrum are typically interpreted as changes in layer thickness, density, and/or moduli.

There are other, known mechanisms that can affect the reflectivity spectrum that are usually neglected. For example, it is well known from the theory of poroelasticity that dynamic, flow characteristics of fluid-filled porous media, such as the viscosity, the permeability or mobility, give rise to dispersion and attenuation effects, which make the moduli complex functions of frequency. Complex frequency dependent moduli are taken to mean elastic moduli with real and imaginary parts that can be frequency dependent. For such media, the reflectivity spectrum acquires additional, intrinsic frequency dependence beyond elastic interference effects, where all the moduli are real functions of frequency.

Methods beyond current seismic processing methods are needed to determine reservoir producibility, dynamic properties of the formation fluids, and/or reservoir permeability. It would be beneficial to be able to extract fluid attributes from the frequency content of the amplitude and phase of seismic data at low frequency. It would also be beneficial to be able to extract fluid attributes even when the size of the interval of interest is below the typical seismic resolution.

### SUMMARY

The present disclosure relates to, for some aspects, a computer-implemented method for determining intrinsic attenuation in a region of a subsurface. The method generally includes obtaining seismic data around the region of the subsurface; processing the seismic data to obtain a reflectivity spectrum in the region of the subsurface; fitting the reflectivity spectrum to analytic formulas as a function of frequency; and determining the intrinsic attenuation in the region of the subsurface based on the fitting.

Other aspects relate to a computer-implemented method for determining a thickness of a thin subsurface bed at a horizon of interest. The method generally includes obtaining seismic data around a region of a subsurface that includes the horizon of interest; identifying the horizon of interest in the region of the subsurface using the seismic data; processing the seismic data to obtain a reflectivity spectrum at the horizon of interest; fitting an amplitude of the reflectivity spectrum at the horizon of interest to an even function of frequency; and determining the thickness of a thin subsurface bed based on the fitting.

### BRIEF DESCRIPTION OF THE DRAWINGS

FIG. 1 shows an exemplary workflow for determining intrinsic attenuation in a region of the subsurface, in accordance with various aspects of the disclosure.

FIG. 2 shows an exemplary workflow for determining the thickness of a thin subsurface bed, in accordance with other aspects of the disclosure.

FIG. 3 shows a diagram of a layered earth model that illustrates poroelastic effects, in accordance with certain aspects of the present disclosure.

FIG. 4 shows schematic illustrating seismic waves reflected and transmitted from an incident wave on a shale-sandstone interface, in accordance with certain aspects of the present disclosure.

FIG. 5A shows reflectivity plotted versus frequency at normal incidence for varying permeability values for a model 0.95 m thickness layered reservoir, in accordance with certain aspects of the present disclosure.

FIG. 5B shows the imaginary part of the reflection coefficient plotted versus frequency for the same permeability values as FIG. 5A, in accordance with certain aspects of the present disclosure.

FIG. 6 shows the real part of the reflection coefficient plotted versus frequency for varying permeability values for the same 0.95 m model reservoir, with an inset showing the misfit function as a function of permeability, in accordance with certain aspects of the present disclosure.

FIGS. 7A and 7B show the real and imaginary parts, respectively, of the reflection coefficient plotted against frequency for varying permeability values for a model 9.5 m thickness layered reservoir, in accordance with certain aspects of the present disclosure.

FIG. 8 shows the misfit plotted as a function of permeability for the 9.5 m model reservoir associated with FIGS. 7A and 7B, in accordance with certain aspects of the present disclosure.

### DETAILED DESCRIPTION

The present disclosure provides a method of separating intrinsic attenuation from attenuation produced by scattering. According to some aspects, the method allows for extracting fluid flow properties from the frequency content of the amplitude and phase of seismic data. Certain aspects of the present disclosure may work when the size of the interval of interest is below the typical seismic resolution. This may enable geological interpreters to make a better determination of the quality of a particular reservoir and de-risk potential candidate reservoirs, as well as correctly identify possible false positives, pinch outs, and potential stratigraphic traps.

In this disclosure, the standard definition of elastic properties, which is familiar to anyone of ordinary skill in the art, is used. In this disclosure, “reflectivity spectrum” refers to expressing the reflectivity as a function of frequency, where expressing may mean representing by means of mathematical formulas or plotting the reflectivity versus frequency.

To “obtain” seismic data, in the context of this disclosure, may refer to any of various methods for doing so, including direct acquisition or retrieval from a library of seismic data. Raw seismic data is generated by various types of sources such as dynamite, air guns, or vibrators either on the earth's surface or offshore. Seismic waves propagate downward and reflect whenever the waves encounter an interface where properties such as the density or rock modulus change abruptly. These reflections travel upward back to the surface and may be recorded by receivers. All such methods of direct acquisition are within the scope of this disclosure.

Once the raw seismic data is obtained, the data typically undergoes a host of standard processing steps such as denoising, deghosting, source deconvolution, spectral reshaping, etc., to eliminate the effects of ambient noise, multiples, ground roll, etc., and extract the true reflection coefficient corresponding to interfaces from which the seismic wave reflects in the ground. “Seismic data,” in the context of this disclosure, refers to this processed seismic signal.

The signal-to-noise ratio can be improved by a method known as stacking or averaging, where several seismic traces are combined into one. Data that is stacked is known as post-stack data, while data before stacking is called pre-stack data. Aspects of the present disclosure apply equally to both pre- and post-stack data, though stacking may boost the signal-to-noise ratio, if the data quality is poor.

Processed seismic data is usually plotted in the form of traces or gathers. A trace refers to a curve made from recorded seismic data in a single channel. A gather is a collection of traces versus source-receiver offset. In this manner, a collection of seismic traces can be obtained for further analysis.

Usually processed seismic data is then converted into a seismic image by use of an appropriate velocity model, which maps the specific reflection event in time to a particular region of the subsurface from where the reflection originated. In some instances seismic images are formed by applying a velocity model directly to the seismic data. Seismic interpreters then use these images to make informed decisions about the possible presence of hydrocarbons.

Therefore the interpreter can go back and forth between the processed seismic image or the seismic data and identify the seismic traces or gathers corresponding to that region of the subsurface. A horizon of interest (or simply, horizon) is a particular interface in the region of the subsurface which gives rise to a seismic reflection. Several commercially available packages can be used to pick and follow horizons in seismic images, and horizon picking is a procedure familiar to those trained in the art. Once a horizon is identified in the image, one can go back to the seismic data and map the traces corresponding to that horizon.

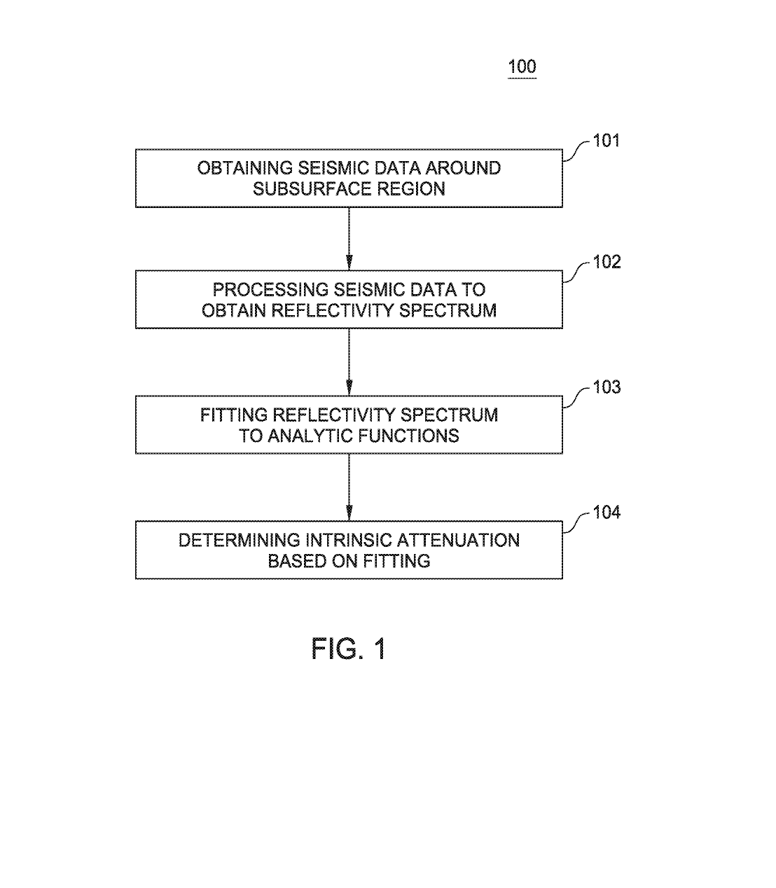

FIG. 1 shows an exemplary workflow 100 for determining intrinsic attenuation in a region of the subsurface. Seismic data for a region of the subsurface is obtained in block 101. Those of ordinary skill in the art will know that the reflectivity can be obtained as traces as a function of space from seismic data in a particular zone of interest by appropriate time or depth migration methods using a pre-determined velocity model.

In block 102, the seismic data is processed to obtain a reflectivity spectrum in the region of the subsurface. This may be done using standard spectral decomposition tools, and for certain aspects, may be done for normal incidence angles. The time-domain reflectivity is a real quantity and can be expressed as R(t)=s(t)*r(t)+n(t), where s(t)*r(t) is a convolution of the seismic wavelet, s(t), with the reflection coefficient, r(t), and n(t) is treated as noise. Seismic processing aims to deconvolve the true reflection r(t) from effects of the source wavelet s(t). Example applications of aspects of the present disclosure are demonstrated below, using synthetic data where noise n(t)=0 and assuming a plane wave source. The Fourier transform of the real reflectivity R(ω)=X(ω)+i Y(ω) is a complex function of frequency (where the real functions, X is the real, and Y is the imaginary part, respectively). The function R(ω) is referred to herein as the reflectivity spectrum. For some aspects of the present disclosure, the amplitude |R|=(X²+Y²)^{1/2} and phase ϕ=arctan(Y/X) are extracted. For others, the real and imaginary parts are extracted.

In block 103, the reflectivity spectrum is fit to analytic functions of frequency. In this disclosure, “analytic formula” or “analytic function” refers to a function of the form: ƒ(ω)=Σᵢ₌₁ⁿaᵢωⁱ, where the coefficients ad may be complex numbers. Functions may be further classified as even or odd, if the power series is entirely composed of even powers or odd powers of frequency, respectively. a₀ may be referred to as the constant term or intercept, a₁ as the linear coefficient, and a₂ as the quadratic coefficient. Likewise, a₄ is the quartic coefficient. For elastic systems, the real part of the reflectivity spectrum is an even function while the imaginary part of the reflectivity spectrum is an odd function.

For some aspects of the present disclosure, the amplitude and phase data are converted into real and imaginary parts of the reflectivity spectrum as functions of frequency to use in subsequent analysis. The real part may be fit to an even function, and the imaginary part may be fit to an odd function. For layered elastic media, the real and imaginary parts of the reflectivity spectrum are constrained to be even and odd functions of frequency. This relationship can also be understood from the fact that the temporal reflectivity signal is real and causal. For other aspects of the present disclosure, the amplitude and phase of the reflectivity spectrum may be fit directly to even and odd functions, respectively.

When a seismic wave passes through rock, the wave energy attenuates through several possible mechanisms. The most basic is geometric spreading of the wave energy. As a second mechanism, the motion of the wave can cause grain motion—that is, motion of rock grains or constituent substances relative to one another—inside the rock medium, causing the wave energy to be absorbed. In the present disclosure, the term “intrinsic attenuation” refers to this second mechanism. A third mechanism still is scattering, whereby waves reflecting off different media interfere with each other or diffract off of structures of size comparable to the wavelength. The present disclosure provides methods of separating intrinsic attenuation from scattering.

When rock is saturated with hydrocarbons, poroelasticity theory teaches that the intrinsic attenuation effects due to wave-induced fluid flow (WIFF) become large when the length scale of the Biot slow wave becomes comparable to the intrinsic rock heterogeneity. Intrinsic attenuation is typically measured by a dimensionless quantity Q⁻¹, which measures the relative loss of energy when one cycle of a pressure p-wave passes through an attenuating medium. Typical dry rocks have an intrinsic attenuation Q⁻¹≈0.005-0.1, which is frequency independent. WIFF effects give rise to a frequency dependent or spectral Q, Q(ω), which in certain cases has a peak in the band of frequencies of about 1-100 Hz where seismic data is typically acquired. If these effects are large, bounds can be placed on fluid flow properties like permeability, fluid mobility, or viscosity. Thus, for some aspects of the present disclosure, the intrinsic attenuation can be used to determine such fluid flow properties in the region of the subsurface.

At block 104 of workflow 100, the intrinsic attenuation is determined based on the fitting. According to some aspects of this disclosure, the relative signs of the quadratic and linear coefficients in the real and imaginary parts of the reflectivity are compared. According to some aspects, in a low intrinsic attenuation/elastic system, the quadratic and linear coefficients are constrained to have opposite signs. For other aspects, if the quadratic and linear coefficients have the same sign, this anomaly serves as an indicator of intrinsic attenuation from wave-induced fluid flow. Equivalently, for other aspects, the signs of the quadratic and quartic coefficients can be compared instead.

According to some aspects, the intrinsic attenuation is determined by computing a misfit between the seismic data and the fitting. The misfit function M indicates some degree of difference between the reflectivity spectrum R(ω) obtained from the seismic data, and an analytic function ƒ(ω), with respect to the coefficients {aᵢ} of the analytic function. Typically, the data only allows the reflectivity to be obtained at a finite number of frequencies {ωᵢ} within a range from some minimum frequency ωₘᵢₙ to a maximum frequency ωₘₐₓ. For some aspects of the present disclosure, a least-squares fitting procedure is used between the minimum and maximum frequency, whereby the misfit function M=Σᵢ|R(ωᵢ)−ƒ(ωᵢ)|² is minimized with respect to the coefficients {aᵢ}. From the least-squares fitting, the fitting coefficients, as well as the misfit (which is equal to the value of the misfit function at the minimum) may be extracted. Alternative ways of defining the misfit function and obtaining fit coefficients and misfit, including situations where the data can be assigned error bars, are well known by those skilled in the art, and should be considered to be within the scope of this disclosure.

If the misfit is smaller than a certain threshold (e.g., about 10%, or alternatively, a threshold that is determined based on the signal-to-noise ratio of the seismic traces, or the variogram of the reflectivity values, or some other statistical method that is familiar to persons skilled in the art of geostatistics), then the system can generally be described by a purely elastic model with no wave-induced fluid flow. A large misfit is a proxy for intrinsic attenuation. Pure interference effects will not produce any misfit, and thus the existence of a misfit naturally separates intrinsic attenuation effects from interference effects. For some aspects, by mapping the changes in the misfit as a function of space in the region of the subsurface, a differential intrinsic attenuation map can be obtained.

For some aspects of the present disclosure, at least one horizon of interest is identified in the region of the subsurface using the seismic data. The intrinsic attenuation may be determined at the at least one horizon of interest as described above. The horizon is selected in such a way that over the spectral bandwidth of the data, the reflectivity at the horizon does not split into multiple peaks. Thus the horizon or of interest is considered to be below the seismic resolution. For some aspects, seismic images may be made using the seismic data, as described above, in order to identify the horizon of interest.

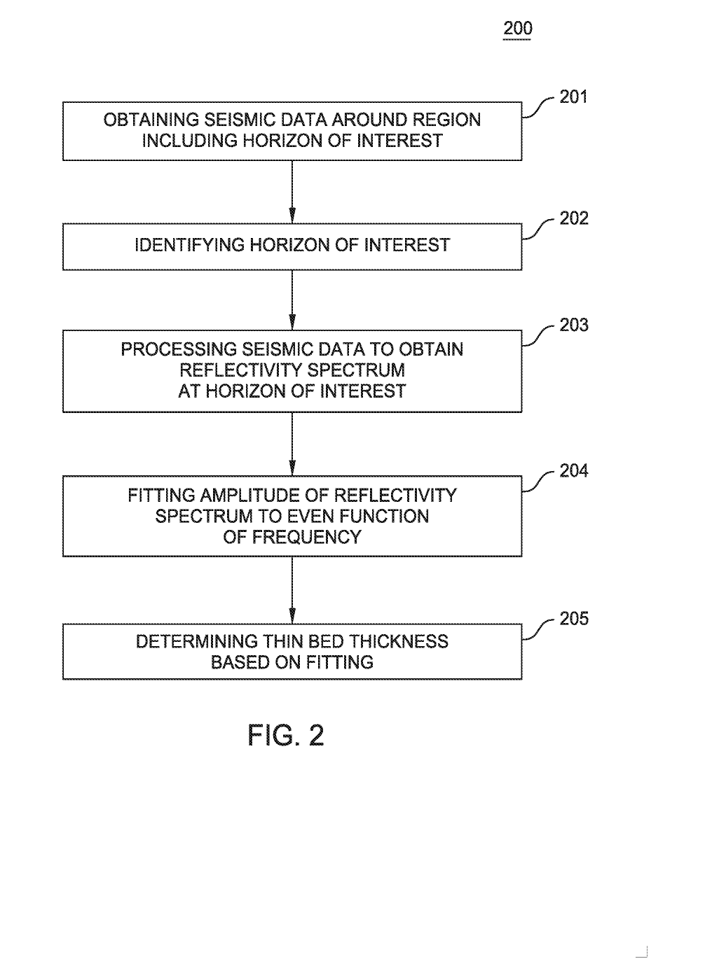

Other aspects of this disclosure may proceed as workflow 200 in FIG. 2, which allows for the determination of the thickness of a thin subsurface bed at a horizon of interest. As the earth is not homogeneous, the reflectivity spectrum changes as a function of space within the region of the subsurface. Here, impedance is defined as the product of density and the p-wave velocity of the rock. In this disclosure, “thin subsurface bed” refers to a horizon of interest of thickness less than about λ/4, where λ is the wavelength of the incident pressure wave. In most geological settings related to hydrocarbon exploration, the wavelength λ can vary from about 10 m to about 100 m; therefore the thin bed thickness may vary from less than 2.5 m to about 25 m.

In block 201, seismic data is obtained for a region of the subsurface that includes the horizon of interest, similarly to methods described above. In block 202, a horizon of interest is selected in the region using the seismic data, as described above. In block 203, the seismic data is processed to obtain a reflectivity spectrum at the horizon of interest, as described above. In block 204, the amplitude of the reflectivity spectrum is fit to an even function of frequency, as described above. And in block 205, the thickness of the thin subsurface bed is determined based on the fitting. According to some aspects, the amplitude of the reflectivity spectrum may be expanded to quartic order, and the thickness may be determined by taking the ratio of the quartic coefficient in the expansion to the square of the quadratic coefficient to extract a thin bed impedance. For instance, the thickness may be solved by using the quadratic formula:

$${ω}^{2} {d}^{2} = {v}_{p}^{2} \frac{- {a}_{2} \pm \sqrt{{a}_{2}^{2} - 4 {a}_{4} ( {a}_{0} - \vert R ( ω ) \vert )}}{2 {a}_{4}} ,$$

where |R(ω)| is the amplitude of the reflectivity spectrum, d is the thickness, and a₀, a₂, and a₄ are the fitting coefficients obtained from the fitting procedure. Here vₚ is the p-wave velocity of the thin bed, which may be obtained from the impedance of the thin bed. Thin bed identification may be done when the misfit is small. In the intermediate regime where WIFF-induced intrinsic attenuation effects are large, producing a large misfit, this may not be possible.

To illustrate the role of poroelastic effects in seismic reflectivity and show example applications of aspects of the present disclosure, consider a layered, permeable reservoir where the total interval thickness and the thickness of the layering are chosen to be much smaller than the seismic wavelength. For simplicity, an alternating gas-brine saturated model where each layer is fully saturated with one fluid is chosen, although this assumption may be relaxed without qualitatively changing the results. In addition to mapping intervals, the method can also be used to map specific horizons of interest such as fluid-fluid contacts or transition zones where rapid variations in heterogeneity and fluid properties are expected to occur. By varying the overall thickness of the region of interest, both cases are illustrated.

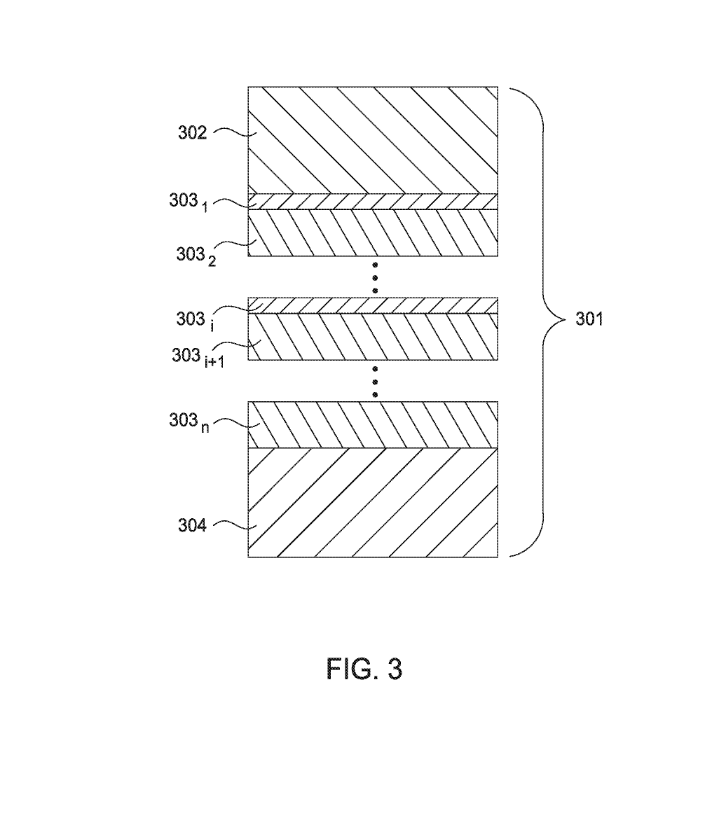

FIG. 3 shows a diagram of an example layered earth model 301, used for the calculations below. The overburden layer 302 and underburden layer 304 are chosen to be impermeable shales, assumed to be semi-infinite. The intervening layers are n alternating units of gas and brine, where the relative thickness ratio of a gas layer to a brine layer is fixed at 0.1. Layer 303₁ is a porous gas layer, layer 303₂ is a porous brine layer, and so on through intervening gas layer 303ᵢ and brine layer 303ᵢ₊₁, ending at brine layer 303ₙ. The basic unit is repeated n/2 times, where the ellipses denote the repeating units. The impedances of the overburden and underburden layers 302, 304 are chosen to be different, with the bottom shale having higher impedance than the top.

For simplicity, a uniform permeability throughout the entire layered system is chosen. Each layer 303₁ to 303ₙ is assumed to be fully isotropic, so the rock parameters are chosen to not vary spatially within a layer, although the parameters do vary from layer to layer. Although simplistic, the model approach described herein can be readily generalized to more realistic saturations which vary from layer to layer, or have spatially varying permeability in the vertical direction. The effect is qualitatively unchanged by including these effects.

The Biot's equations for a fluid-filled porous medium are:

$$\begin{matrix}{ρ}_{b} \frac{{\partial }^{ 2} u}{\partial {t}^{ 2}} + ρ \frac{{\partial }^{ 2} w}{\partial {t}^{ 2}} = ( λ + μ ) ∇ div u + μ {∇}^{2} u + 2 γ D ∇ div u & ( 1 ) \\ {ρ}_{f} \frac{{\partial }^{ 2} u}{\partial {t}^{ 2}} + m \frac{{\partial }^{ 2} w}{\partial {t}^{ 2}} + \frac{η}{κ} \frac{\partial w}{\partial t} = 2 D ∇ div u + 2 γ D ∇ div u & ( 2 )\end{matrix}$$

where ρ_{b}, ρ_{f} denote the saturated rock and fluid density respectively and ρ_{b}=(1−φ)ρₛ+φρ_{f}. Here, ρₛ is the density of the solid grains comprising the rock matrix, and φ is the porosity. The solid and fluid displacement vectors are denoted as u and w respectively, and the constants λ, μ are the two Lame parameters of the fluid saturated rock. The parameter m is a phenomenological parameter which governs the coupling of the rock to the fluid matrix and is given by m=S ρ_{f}/φ, where S is the structure factor of the pores, which accounts for the shape and tortuosity. Here γ=1−Kₘ/Kₛ and D=Kₛ/2(γ+φ/K_{f}(Kₛ−K_{f}))⁻¹ where Kₛ, Kₘ are the bulk moduli of the grains comprising the rock matrix and the dry rock matrix. Similarly, K_{f} is the fluid modulus. The mobility parameter η/κ controls the movement of the fluid in the rock for fluid viscosity η and the rock permeability κ.

For homogeneous media, the equations above may be solved in Fourier space using standard methods to obtain the wave-vectors of the three waves: P-wave kₚ, S-wave kₛ, and slow wave k_{b}. While the wave-vectors for the fast P- and S-waves are only weakly dependent on the mobility, the wave-vector for the slow wave depends strongly on the mobility, is diffusive in nature, and scales as

$${k}_{b} \approx \sqrt{\frac{i ωη}{κ {K}_{f}}}$$

at the low frequencies of interest in the seismic band. The expression becomes exact in the limit of zero frequency. The wave vectors are solved for exactly at each frequency, retaining both the real and imaginary parts. A critical frequency wait may be defined when for a given heterogeneity scale, l, the wavelength of the slow wave becomes comparable to the heterogeneity scale: ω_{crit}≈4πκK_{f}/ηl².

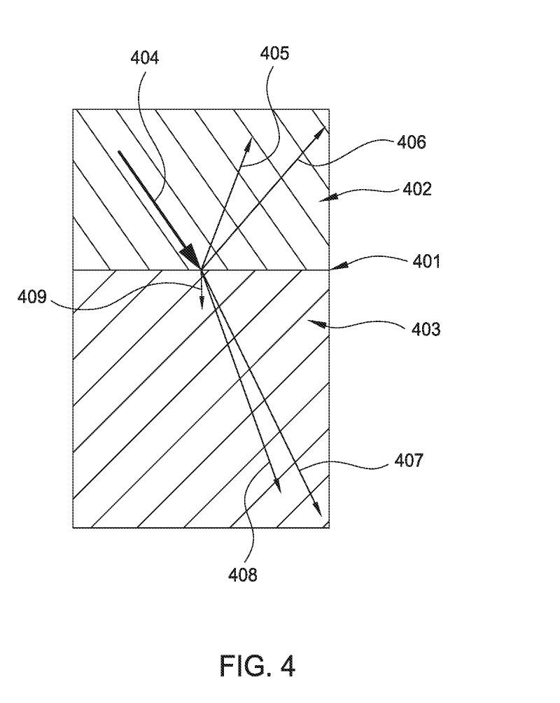

FIG. 4 shows that at the interface 401 between an impermeable shale 402 and a porous sandstone 403, three waves are transmitted rather than two, illustrating the poroelastic effects discussed in this disclosure. Interface 401 might represent a horizon of interest to be analyzed via the methods of this disclosure. An incident wave 404 generates transmitted and reflected P-waves 407 and 406, and transmitted and reflected S-waves 408 and 405. The third transmitted wave, slow wave 409, also called the Biot slow wave, is diffusive in nature and has a much smaller wavelength than the P- and S-waves. The present disclosure highlights the important role of the slow waves on the P-wave reflectivity of a layered system in the frequency band of interest to seismic exploration.

The physics behind the present disclosure can be understood as follows. When a pressure wave is incident on the surface of a heterogeneous, layered rock, the transmitted waves include pressure waves, shear waves, and diffusive slow waves which carry energy. More compressible layers (filled with gas) are displaced more than rocks with less compressible fluids (such as brine or oil). This sets up an interlayer fluid pressure gradient. The slow wave is responsible for the equilibration of fluid pressure gradients, and the timescale for pressure equilibration is controlled by the diffusivity of these slow waves. In impermeable media, the slow wavelength is much smaller than the heterogeneity; the layers cannot communicate fluid pressure with each other and can be treated as purely elastic and independent. On the other hand, in highly permeable rocks, the slow wavelength can be comparable to the heterogeneity itself, and thus diffusive slow waves can propagate and interfere between different layers. As slow waves carry energy away from the fast P-waves, this mesoscopic fluid movement offers a new mechanism for attenuation of P-waves. There is also a coherent effect, where propagating slow waves on short distances interfere with P-waves, and thus also modify seismic reflection coefficients.

The interference of slow waves occurs at a characteristic wavelength, which is proportional to the fluid mobility. As interference is a coherent phenomenon, the effect can be greatly amplified by increasing the number of layers. Although slow waves cannot be observed directly, apart from carefully designed laboratory experiments, their effect is apparent in the amplitude and phase of the reflected P-wave, which is actually measured by seismic receivers. This interference effect is naturally absent in effective medium theories, which do not explicitly retain the slow wave in their treatment, but only keep their effects as a loss term in the P-wave slowness. Furthermore, prior works on this subject tend to model semi-infinite interfaces and thus miss coherent interference effects arising from wave conversion from pressure to slow waves and vice versa.

To calculate the reflectivity in a highly layered medium, the present disclosure, for some aspects, generalizes the method of Kennett and Kerry. The Kennett-Kerry method requires one to first calculate the reflection (R) and transmission (T) coefficients for up (U) and downgoing (D) P-, S-, and slow waves at each interface. These coefficients are computed by assuming continuity of solid and fluid displacement u and w, and continuity of fluid pressure p and vertical and shear stress τ_{zz} and τ_{xz}. As the example system is homogeneous and isotropic, the shear stress is assumed to be everywhere constant in the horizontal plane, and the problem becomes effectively one-dimensional. Once the reflection/transmission coefficients are obtained, the coefficients are put in a 3×3 matrix form to obtain the total reflection/transmission matrix at interface i:

$${R}_{i}^{D} = ( \begin{matrix}{R}_{pp} & {R}_{bp} & {R}_{sp} \\ {R}_{pb} & {R}_{bb} & {R}_{sb} \\ {R}_{ps} & {R}_{bs} & {R}_{ss}\end{matrix} ) \qquad ( 3 )$$

Where Rᵢ^{D} is the total downgoing reflection matrix at interface i, and Rij denotes the reflected amplitude of a wave of type j (j={p, s, b}) for an incident downgoing wave from medium i to medium i+1 of type i (i={p, s, b}). Similar 3×3 matrices are defined for upgoing reflected waves and up and downgoing transmitted waves.

The waves generated at the interface acquire a phase shift proportional to their respective wave-vectors as the waves propagate through the interface. The wave vectors are captured in a phase matrix Eᵢ given by

$${E}_{i} = ( \begin{matrix}{e}^{{ik}_{pi} {d}_{i}} & 0 & 0 \\ 0 & {e}^{{ik}_{bi} {d}_{i}} & 0 \\ 0 & 0 & {e}^{{ik}_{bi} {d}_{i}}\end{matrix} ) \qquad ( 4 )$$

where kₚᵢ, k_{bi}, kₛᵢ are the wave-vectors of each of the three waves produced at the interface.

The total reflectivity at the top of interface i is obtained according to the formula:

[symbol]

ᵢ^{D}=Rᵢ^{D}+Tᵢ^{D}(Eᵢ₊₁Rᵢ₊₁^{D}Eᵢ₊₁)(I−Rᵢ^{U}Eᵢ₊₁Rᵢ₊₁^{D}Eᵢ₊₁)⁻¹Tᵢ^{U} (5)

For the bottom-most interface N, the reflectivity [symbol] _{N}^{D}=R_{N}^{D}, and a recursion is started by sequentially stacking layers from the bottom to the topmost layer. The total horizon reflectivity is calculated when the recursion reaches the top layer 303₁ of FIG. 3. A key advantage of this method over other methods is that the role of multiples and wave-conversion between multiples is automatically included. This can be readily seen by expanding the matrix inverse.

The reflectivity of an elastic system of arbitrary many layers of arbitrary thickness scales with even powers of frequency for all frequencies. A weaker form of this strong result generalizes to viscoelastic systems, where the result is only valid at low frequencies. The present disclosure, for some aspects, uses this important result to extract a qualitative measure of the fluid mobility in permeable rocks.

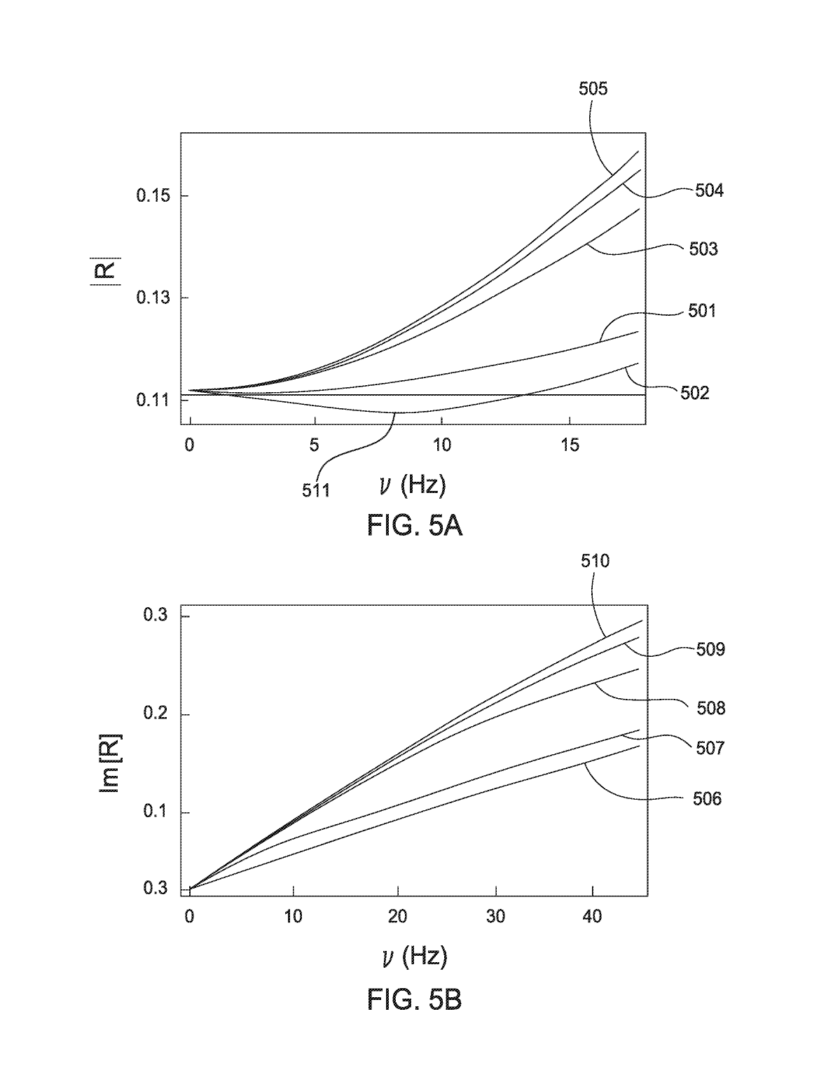

As an example application of aspects of the present disclosure, FIG. 5A is a plot of the magnitude of the reflectivity spectrum versus frequency for a model alternating gas-brine system, of the type shown in FIG. 4, of 15 layers of total thickness 0.95 m, with a relative gas saturation of 0.1. Relative gas saturation refers to the fraction of the total fluid occupying the pore space that is gas. Similarly, in the case of a fully saturated gas-brine system, a relative brine saturation may be defined as 1 minus the relative gas saturation. The thickness of each gas layer is 0.63 cm, and the thickness of each water layer is 5.7 cm. The total package thickness is small enough that this would not be resolved by seismic waves. This could therefore represent a single horizon.

Reflectivity is plotted as a function of frequency for different values of the permeability. Curve 501 represents the elastic case of zero permeability. Curve 502 is for permeability κ=10⁻³ darcies (D), curve 503 is for κ=10⁻² D, curve 504 is for κ=10^{-3/2} D, and curve 505 is for 10⁻¹ D. The amplitude and phase change with increasing permeability at intermediate frequencies. This is in stark contrast with current seismic modeling workflows which retain fluid effects on rocks in terms of their static, elastic properties. All poroelastic effects are neglected, yet FIG. 5A shows that these effects can dramatically alter the reflection coefficients, and thus have an observable effect on seismic data. With increasing permeability, a dip feature 511 develops in the reflection amplitude. The dip feature occurs when the impedance of the underburden exceeds that of the overburden, which typically occurs in the subsurface. The dip feature is a new observation and indicates the length of the heterogeneity scale becomes comparable to the wavelength of the slow wave. As the wavelength of the slow wave in the system is controlled by permeability, the dip feature is an indirect measurement of the permeability of the system. This feature is absent in effective medium theories which model the reflectivity versus frequency, and even in models which explicitly model slow wave effects but only in semi-infinite interfaces.

In poroelastic, layered systems, the reflection coefficient is not a real number, but rather a complex quantity with an amplitude and a phase. It may not be sufficient to simply look at the absolute value; the real part of the reflection coefficient should also be considered. At normal incidence, defined as when the offset between the source and receiver is zero, the sign of the real part at a given interface is an indicator of the change in impedance from one layer to the next. A positive reflection coefficient corresponds to waves traveling from low to high impedance, and a negative reflection coefficient indicates vice versa.

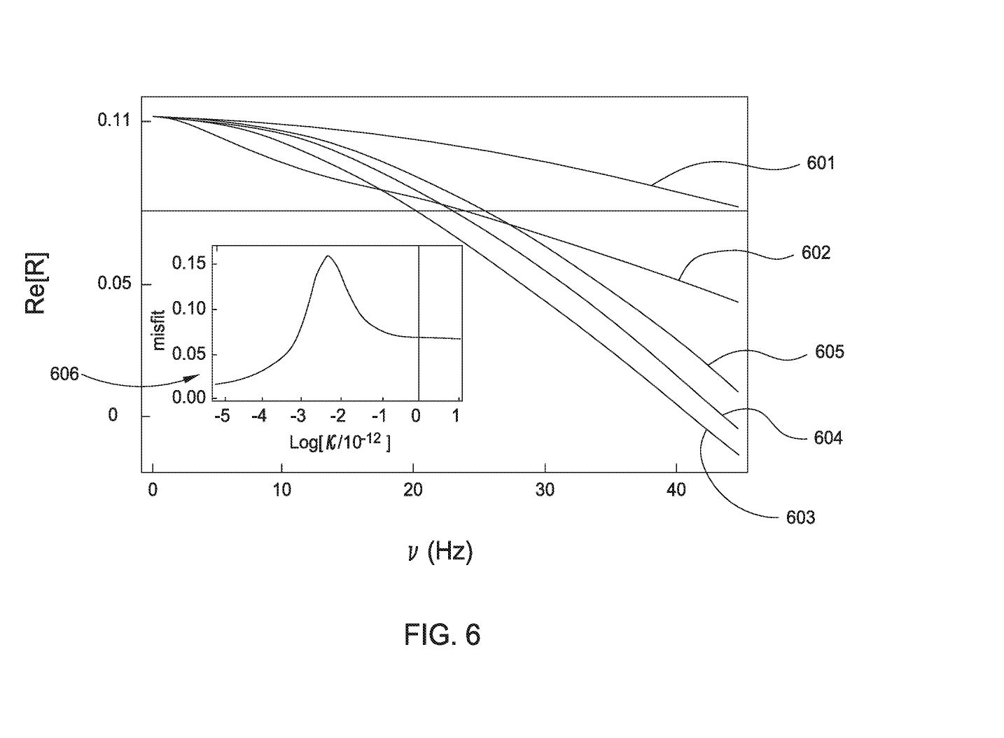

In FIG. 5B and FIG. 6, the imaginary and real parts of the reflection amplitude are plotted. Curves 506 and 601 represent the elastic case. Curves 507 and 602 are for κ=10⁻³ D, curves 508 and 603 are for κ=10⁻² D, curves 509 and 604 are for κ=10^{-3/2} D, and curves 510 and 605 are for 10⁻¹ D. The imaginary part is roughly linear over a range of frequencies developing curvature at higher frequencies. The characteristic frequency where this function deviates from linearity depends on the total thickness of the package, and is set by a combination of interference and poroelastic effects. For some aspects of the present disclosure, in order to separately isolate these effects and extract poroelastic effects from the reflectivity, both the real and imaginary parts of the reflection coefficient must be considered. For other aspects, the amplitude and phase may be considered.

While the real part of the reflection coefficient is purely positive in the elastic case, the real part changes sign as a function of frequency at high frequencies in the poroelastic case, implying that the poroelastic reflectivity corresponds to a different effective impedance for the intermediate layer compared to the elastic results.

The low permeability reflectivity very closely approximates a quadratic function of frequency. However, with increasing permeability, the reflectivity deviates from this quadratic form, and can no longer be captured by purely even powers of frequency alone. This is particularly dramatic in the 1 mD (=10⁻³ D) case, where previously the dip feature appeared in the absolute value of the reflectivity. The deviation from purely even powers of frequency can be qualitatively captured by a misfit function m=Σ_{ω}|R−ƒ(ω)|², where R denotes the numerically computed real part of the reflection coefficients in the inset of FIG. 6 and ƒ(ω)=Σₙ₌₀ⁿ^{ₘₐₓ}aₙω²ⁿ is the best fit even polynomial function, where the polynomial expansion is truncated at some integer nₘₐₓ. The particular quantity of interest is the quadratic coefficient. The expansion is truncated when the addition of higher order terms creates a variation of less than about 1% in the quadratic term. For the very thin reservoir considered, particularly at low frequencies, only the lead quadratic and linear terms in the expansions of the real and imaginary parts may be retained. Similarly, for aspects using the amplitude and phase, only the quadratic and quartic parts of the amplitude may be retained for thin reservoirs at low frequencies.

Inset plot 606 of FIG. 6 shows misfit plotted as a function of permeability. The misfit is largest at 1 mD, shown by curve 602, where the dip feature first appears, highlighting the point where the slow wave wavelength matches the heterogeneity scale. For higher permeability, the misfit decreases, and the real part of the reflectivity can again be approximated by an even function. This means that at higher permeability, the interface appears approximately elastic, but with a different impedance compared to the elastic case. For increasing permeability, the slow-wave wavelength increases, allowing the waves to re-equilibrate the fluid pressure between the layers. As the fluid pressure equilibrates, this endows the fluid-saturated layers with a different compressibility. At low permeability, when the fluid layers are not in communication, the effective modulus is equivalent to that of the Backus average of the two fluids. The Backus average is identical to the high frequency Biot-Gassman-Hill (BGH) effective modulus for layered media.

For patchy saturation models, the effective bulk (p-wave) modulus of the fluid saturated rock Kₛₐₜ at is given by substituting the Biot-Gassman-Wood (BGW) formula for the effective fluid modulus:

$${K}_{eff} = {( \frac{1 - {S}_{g}}{{K}_{w}} + \frac{{S}_{g}}{{K}_{g}} )}^{- 1} \qquad ( 6 )$$

into the Gassmann formula for fluid substitution:

$${K}_{sat} = {K}_{m} + \frac{{( 1 - \frac{{K}_{m}}{{K}_{s}} )}^{2}}{\frac{{K}_{m}}{{K}_{s}} + ϕ ( \frac{1}{\frac{1}{{K}_{eff}} - \frac{1}{{K}_{s}}} )} \qquad ( 7 )$$

Here S_{g}=0.1 is the gas saturation (or the total volumetric fraction of gas in the layered system we consider) and K_{g}, K_{w} are the P-wave moduli of the gas and other fluids. The BGW formula corresponds to the opposite limit, where fluid pressure can equilibrate between the layers.

The intrinsic attenuation arising from poroelastic effects may have a peak as one crosses over from BGW to BGH limits. For mesoscopic heterogeneities, of size much smaller than the seismic wavelength but much larger than the pore size, this intrinsic attenuation peak occurs in the seismic band (about 1-100 Hz). Different regions of space will have different permeabilities and hence different intrinsic attenuation or different misfits. For some aspects of the present disclosure, the misfit may thus be plotted as a function of space within the region of the subsurface, creating a differential attenuation map. By mapping out the misfit, a map of how the intrinsic attenuation varies across the subsurface can be created. The differential attenuation map may be used for identifying fluids and fluid flow properties such as permeability, mobility, and viscosity.

The effective impedance of this intermediate layer is computed using the formula, valid for low frequencies ω<<vₚ/l:

$$R = {R}_{ω = 0} + \frac{2 i ω l}{{I}_{i} {v}_{p}} \frac{( {I}_{b}^{2} - {I}_{i}^{2} )}{{( {I}_{b} + 1 )}^{2}} - 2 \frac{ {ω}^{2} {l}^{2}}{{I}_{i}^{2} {v}_{p}^{2}} \frac{( {I}_{b}^{2} - {I}_{i}^{2} )}{{( {I}_{b} + 1 )}^{3}} ( {I}_{b} + {I}_{i}^{2} ) \qquad ( 8 )$$

where I_{b}=ρ_{b}v_{pb}/ρₜvₚₜ and Iᵢ=ρᵢvₚ/ρₜvₚₜ are the normalized impedances of the bottom and intermediate layers, normalized to the impedance of the top shale. Here the constant intercept term R_{ω=0}=(I_{b}−1)/(I_{b}+1) and l is the total thickness of the intermediate layered medium, set to be 0.95 m.

If the misfit is small (e.g. smaller than about 10%, or alternatively, a threshold that is determined based on the signal-to-noise ratio of the seismic traces, or the variogram of the reflectivity values, or some other statistical method that is familiar to persons skilled in the art of geostatistics), then the system may be described by an elastic system. In this case, the ratio of the squared quadratic coefficient of the amplitude to the quartic coefficient may be taken. In other aspects, the ratio of the quadratic coefficient of the real part to the squared coefficient of the imaginary part may be taken, although this may result in phase ambiguities. As the equation above shows, this eliminates an important unknown parameter, namely the thickness. The normalized impedance of the bottom layer to the top layer is determined from the DC value of the reflectivity given by the constant fitting term. Thus, the only unknown is the intermediate layer impedance, which is readily determined by solving equation (8).

The model above is valid for a thin layer, where the thickness of the interval is much smaller than the seismic wavelength. Below it is shown that the effects described are robust against interference effects, and thus could also be used for mapping permeable reservoirs with layered stratigraphy.

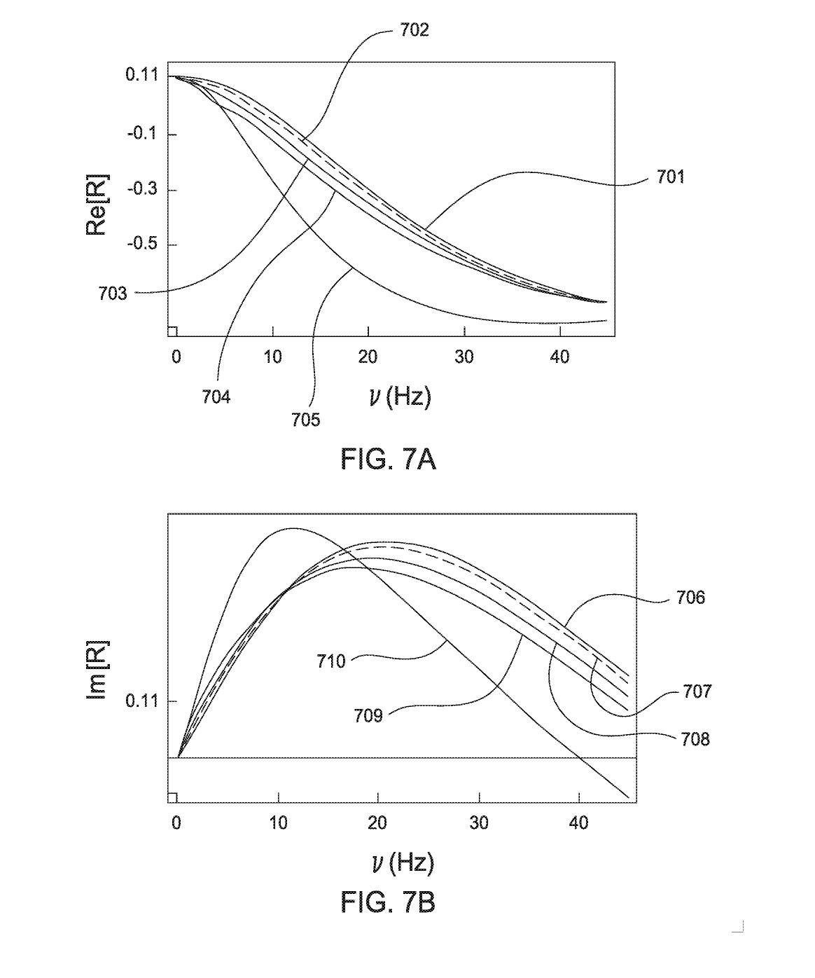

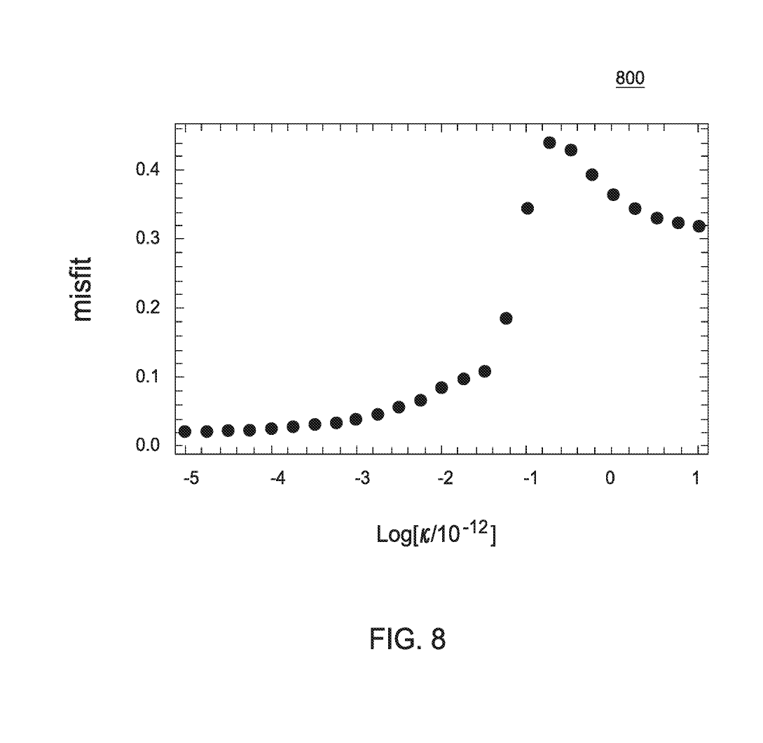

FIGS. 7A, 7B, and 8 are for an example application of some aspects of the present disclosure. The model is as before, with alternating brine and gas layers, but with the total thickness of the package increased by a factor of 10, to be consistent with typical reservoir dimensions of about 9.5 m. Reservoirs of such thickness are usually in the so-called “tuning” regime, where the finite thickness of the reservoir is within the seismic resolution and thus produces a spectral response due to interference. Aspects of the present disclosure can extract poroelastic effects associated with permeability that exist on top of the existing interference signal. In this example, the number of layers is fixed at 15, and the relative gas saturation at 0.1. Other aspects may have a number of layers between about 10 and about 20, and/or relative gas saturation between about 0.05 and about 0.15. This yields a gas layer thickness of about 6.3 cm and brine layer thickness of about 57.1 cm. As the P-wave velocity of the intermediate layer is 2000 m/s, the expansion remains valid for frequencies ω≤2000/10=200 m/s, which is larger than the typical seismic bandwidth.

The real and imaginary parts of the reflectivity are plotted in FIGS. 7A and 7B, respectively. Curves 701 and 706 are the elastic case. Curves 702 and 707 are for κ=10⁻³D, curves 703 and 708 are for κ=10⁻² D, curves 704 and 709 are for κ=10^{-3/2} D, and curves 705 and 710 are for κ=10⁻¹ D. Because of the large size of the reservoir, the reflectivity has a much larger amplitude change with frequency, which is the well-known standard tuning effect. Again, while the reflectivity changes dramatically with permeability, the reflectivity remains close to the elastic value until the permeability gets larger than 10⁻¹ D, as shown by the deviation of curves 705 and 710 from curves 701 and 706. The reason for this is that the increased heterogeneity scale implies that in order for ω_{crit} to be in the seismic band, the permeability needs to be about 100 times higher than before. This follows from the definition of ω_{crit}, which scales only linearly with the permeability but with the square of the spatial heterogeneity. Thus the effects which were observed in the smaller model reservoir at 10⁻³ D now occur at 10⁻¹ D.

The methodology to determine the effective modulus of the rock remains the same as before, and is reflected in the plot 800 of FIG. 8, which shows the misfit function for the model 9.52 m thickness reservoir. To minimize the influence of interference effects, only the low frequency part of the data is considered. By fitting the real and imaginary parts of the reflectivity to the exact formulas above, the permeability-dependent misfit and the P-wave modulus difference can be extracted. As before, even in this case where interference effects can occur, the misfit shows a similar behavior: a large misfit is obtained for permeabilities <100 mD but becomes vanishingly small for larger permeability. By mapping the misfit, the variability in intrinsic attenuation in the subsurface can be extracted.

Any of the operations described above may be included as instructions in a computer-readable medium for execution by a control processing unit (CPU) or any other processing system. The computer-readable medium may comprise any suitable memory for storing instructions, such as read-only memory (ROM), random access memory (RAM), flash memory, an electrically erasable programmable ROM (EEPROM), a compact disc ROM (CD-ROM), a floppy disk, and the like.

The methods detailed in aspects of the present disclosure may be incorporated into a hydrocarbon detection program, which may be stored in the memory of a processor configured incorporated into a hydrocarbon detection system. The system may output the results of the program, such as an indication of the presence of hydrocarbons in a subsurface region, to storage or to a display. The output of the system may then be used to control operations, such as drilling or hydrocarbon extraction operations. For instance, according to some aspects, drilling or hydrocarbon extraction operations may be controlled based on the intrinsic attenuation determined in workflow 100 of FIG. 1. For other aspects, operations may also be controlled based on a created differential attenuation map, or based on fluid flow properties determined based on the intrinsic attenuation.

The foregoing description is directed to particular example aspects of the present technological advancement. It will be apparent, however, to one skilled in the art that many modifications and variations to the aspects described herein are possible. All such modifications and variations are intended to be within the scope of the present disclosure, as defined in the appended claims.

### REFERENCES

Kennett, B. L. N. and Kerry, N.J. (1979), “Seismic waves in a stratified half-space,” Geophys. J. Roy. Astr. Soc. 57, pp. 557-583.

1. A computer-implemented method for determining intrinsic attenuation in a region of a subsurface, comprising:
obtaining seismic data around the region of the subsurface;
processing the seismic data to obtain a reflectivity spectrum in the region of the subsurface;
fitting the reflectivity spectrum to analytic functions of frequency; and
determining the intrinsic attenuation in the region of the subsurface based on the fitting.

2. The method of claim 1, wherein the determining comprises:
identifying at least one horizon of interest in the region of the subsurface using the seismic data, and
determining the intrinsic attenuation at the at least one horizon of interest based on the fitting.

3. The method of claim 2, wherein the identifying comprises generating seismic images using the seismic data.

4. The method of claim 1, further comprising:
using the intrinsic attenuation to determine fluid flow properties in the region of the subsurface.

5. The method of claim 4, wherein the fluid flow properties comprise at least one of permeability, fluid mobility, or viscosity.

6. The method of claim 1, wherein the fitting comprises using a least-squares method between a minimum frequency of the reflectivity spectrum and a maximum frequency of the reflectivity spectrum.

7. The method of claim 6, wherein the fitting further comprises:
fitting an amplitude of the reflectivity spectrum to an even function, and
fitting a phase of the reflectivity spectrum to an odd function.

8. The method of claim 6, wherein the fitting further comprises:
fitting a real part of the reflectivity spectrum to an even function, and
fitting an imaginary part of the reflectivity spectrum to an odd function.

9. The method of claim 1, wherein the determining comprises computing a misfit between the seismic data and a fit of the reflectivity spectrum based on the fitting.

10. The method of claim 9, further comprising:
creating a differential intrinsic attenuation map by plotting the misfit as a function of space within the region of the subsurface.

11. The method of claim 1, wherein the processing comprises obtaining the reflectivity spectrum at normal incidence.

12. A computer-implemented method for determining a thickness of a thin subsurface bed at a horizon of interest, comprising:
obtaining seismic data around a region of a subsurface that includes the horizon of interest;
identifying the horizon of interest in the region of the subsurface using the seismic data;
processing the seismic data to obtain a reflectivity spectrum at the horizon of interest;
fitting an amplitude of the reflectivity spectrum at the horizon of interest to an even function of frequency; and
determining the thickness of the thin subsurface bed based on the fitting.

13. The method of claim 11, wherein the determining comprises:
expanding the amplitude of the reflectivity spectrum to quartic order; and
taking a ratio of a quartic coefficient and a squared quadratic coefficient of an expansion of the amplitude of the reflectivity spectrum to quartic order to extract a thin bed impedance.
